(19) United States
(12) Patent Application Publication
(10) Pub. No.: US 2007/0146773 A1
(43) Pub. Date: Jun. 28, 2007

(54) MULTIFUNCTION DEVICE AS A PORTAL TO A WIDE AREA NETWORK AND MONITOR FOR A LOCAL AREA NETWORK

(75) Inventors: Steven J. Harrington, Webster, NY (US); Donna S. German, Rochester, NY (US); Fred J. Miller, Ontario, NY (US); Gerry E. Hudson, Penfield, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/379,635

(22) Filed: Apr. 21, 2006

Related U.S. Application Data
(60) Provisional application No. 60/753,050, filed on Dec. 22, 2005.

(51) Int. Cl. G06F 3/12

(52) U.S. Cl. 358/1.15

(57) ABSTRACT

A system includes a multifunction peripheral device. The multifunction peripheral device provides scanning, printing, copying, and faxing functionality. A wide area network is communicatively connected to the multifunction peripheral device and a remote device. A local area network is communicatively connected to the multifunction peripheral device and a plurality of local workstations. The multifunction peripheral device provides an interface between the wide area network and the local area network.

### PRIORITY INFORMATION

1. The present patent application claims priority under 35 U.S.C. §119(e) from U.S. Provisional Patent Application Ser. No. 60/753,050, filed on Dec. 22, 2005. The entire content of U.S. Provisional Patent Application Ser. No. 60/753,050, filed on Dec. 22, 2005 is hereby incorporated by reference.

### BACKGROUND

Many businesses supply file servers for file and document storage for their employees as well as backup services that can prevent data loss when hardware fails and enable recovery of files that may have been accidentally deleted. Moreover, many of these entities support an information technology department with trained and dedicated staff for security issues.

Also, many entities with internal computer networks (and the information technology departments that support the internal computer networks) typically monitor the devices attached to the networks. The monitoring determines when a device is getting low on storage or when a software application is obsolete or incompatible with other applications. Monitoring can determine which software applications are heavily used and which are not used at all.

Furthermore, many entities with internal computer networks (and the information technology departments that support the internal computer networks) typically have a set of basic services operating on the internal computer networks. The services can include domain name services to convert mnemonic names into IP addresses; naming services that clients can query to receive values associated with names; time services that provide accurate fault-tolerant clock synchronization for machines on the network; token services for synchronization and locks; logging services br processing client logs. Other capabilities such as email, file transfer, and web servers are usually also supported.

On the hand, many smaller businesses could benefit from the various services discussed above, but most likely these entities lack the hardware, expertise and time to implement them. However, these entities may have a multifunction peripheral device for printing, faxing, and scanning. If these entities have several workstations, these entities commonly connect the several workstations by a local network to each other and to the multifunction peripheral device. Furthermore, it is not uncommon for such entities to have a shared Internet connection.

It is also typical for the multifunction peripheral device to have some amount of storage. This is normally used to store fax images that are received, or are about to be sent as well as for saving scanned images or documents to be printed.

A small office with a few workers and workstations can have the same security issues (virus protection, spam, password control, etc.) as larger offices. However, while a large company can support an information technology department with trained and dedicated staff for security issues, those resources may be unavailable to the small office.

Thus, it is desirable to enable the multifunction peripheral device to provide the abovementioned services. It is desirable that the multifunction peripheral device provide local and remote backup services. Furthermore, it is desirable to provide a multifunction peripheral device that is capable of monitoring the devices attached to a local area network.

Also, it is desirable to provide a multifunction peripheral device that is capable of providing domain name services to convert mnemonic names into IP addresses; naming services that clients can query to receive values associated with names; time services that provide accurate fault-tolerant clock synchronization for machines on the network; token services br synchronization and locks; logging services for processing client logs.

It is further desirable to provide a multifunction peripheral device that is capable of providing email capabilities, file transfer capabilities, and web servers.

Lastly, it is desirable to provide a multifunction peripheral device that is capable of providing security services.

### BRIEF DESCRIPTION OF THE DRAWINGS

The drawings are only for purposes of illustrating an embodiment and is not to be construed as limiting, wherein:

FIG. 1 illustrates the architecture of a multifunction peripheral device; and

FIG. 2 illustrates a block diagram of a configuration of a system using a multifunction peripheral device as a portal to a wide area network.

### DETAILED DESCRIPTION

For a general understanding, reference is made to the drawings. In the drawings, like references have been used throughout to designate identical or equivalent elements. It is also noted that the drawings may not have been drawn to scale and that certain regions have been purposely drawn disproportionately so that the features and concepts could be properly illustrated.

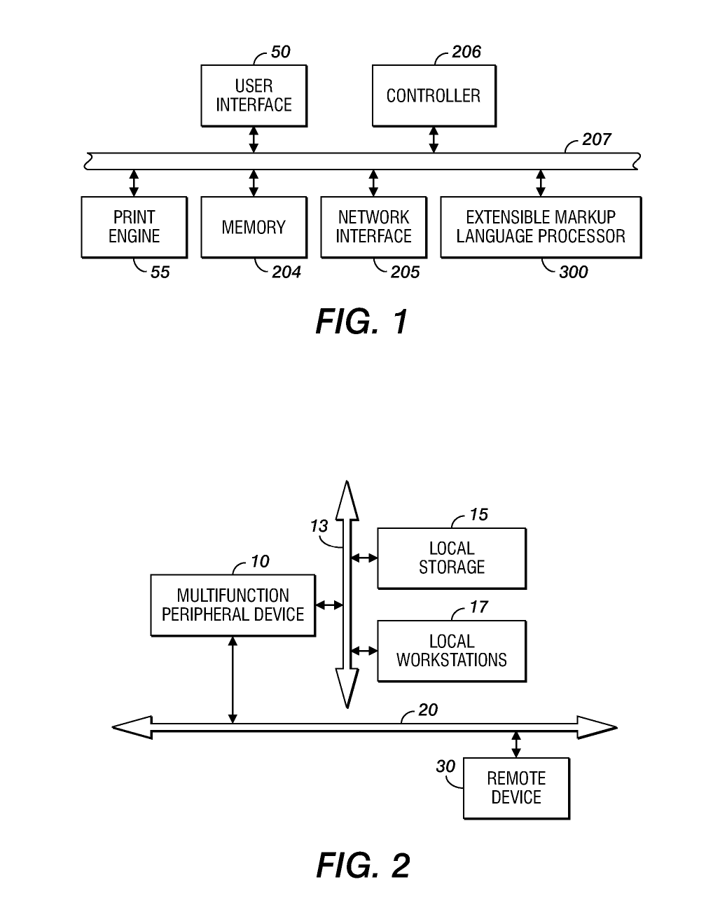

FIG. 1 illustrates a configuration for utilizing a multifunction peripheral device to realize the various services and functionality described below. As illustrated in FIG. 1, a multifunction peripheral device 10 is connected to a wide area network 20. The multifunction peripheral device 10 is capable of scanning, printing, copying, and/or faxing documents.

The multifunction peripheral device 10 is further connected, through a local area network 13, to local storage 15 and local workstations 17. It is noted that the local storage 15 may be additional memory residing in the multifunction peripheral device 10. A variety of remote devices or service providers 30 are connected to the wide area network 20. The multifunction peripheral device 10 can access these external devices and services and provide a common interface to them for the local workstations 17. In addition the multifunction peripheral device can automate many of the tasks associated with accessing these services in a way the eliminates the need for a specialized IT department or staff, thus expanding the range of support functions available to the smaller businesses.

As a first example the remote device or service 30 can store files and provide essentially unlimited storage. Such a remote device or service not only offers the flexibility of large storage amounts when needed, but can also offer the security of backup storage and redundancy if desired. The remote device or service 30 could provide document and data archival with convenient electronic access.

The multifunction peripheral device 10 can also act as a file cache to maintain local network copies of frequently used files. When files are stored, the files can be saved on the multifunction peripheral device 10 and also transferred to the remote device or service 30.

When a file is needed, the system checks first to see if the file is available on the multifunction peripheral device 10 before requesting it from the remote device or service 30. Files that have not been recently accessed can be deleted from the multifunction peripheral device 10 to make room for more active files utilizing common cache management algorithms.

Another function that the multifunction peripheral device can provide is backup. The multifunction peripheral device 10 can periodically review the file systems of the local workstations 17. Changes to these file systems, or copies of these file systems in their entirety can be retrieved by the multifunction peripheral device 10 and transferred to the remote device or service 30 for backup. If a file must be retrieved from backup (e.g. because it was accidentally deleted locally), a request can be made to the multifunction peripheral device 10. The multifunction peripheral device 10 can then forward the request to the remote device or service 30. The remote device or service 30 recovers or reconstructs the desired file and provides the file to the requestor through the multifunction peripheral device 10.

A further service that can be provided by the multifunction peripheral device is encrypting and decrypting files to preserve the privacy of the data. If a file transfer to the remote device or service 30 occurs through the multifunction peripheral device 10, the multifunction peripheral device 10 can encrypt a file before forwarding it to the remote device or service 30. When a file is received back from the remote device or service 30, the multifunction peripheral device 10 can decrypt the file before making the file locally available. This can preserve the privacy of the data being transferred over the wide area network 20 and stored on the remote device or service 30.

Because of its position as the interface to the wide area network 20, the multifunction peripheral device 10 can provide security functions to the local area network 13 and its citizens/clients. One such security feature firewall protection. This security feature controls access to the local area network 13 from the wide area network 20 and vice versa. The multifunction peripheral device 10 can also support dial-up access, providing the connection and controlling who has access to the local area network 13 via phone lines.

In addition to access control, the multifunction peripheral device 10 can support virus protection. The multifunction peripheral device 10 can contain virus scanning software that reviews all files transferred across the local area network 13.

The multifunction peripheral device 10 can also scan files on local workstations 17 for viruses or provide the workstations 17 with the latest virus description files for use in self-scanning by the workstations 17. Thus, the multifunction peripheral device 10 acts as the interface to a virus protection service, from which he multifunction peripheral device 10 acquires the latest virus protection software and data updates.

Another function that the multifunction peripheral device 10 can also provide is to serve to patch vulnerable software. Software patches could be provided to the multifunction peripheral device 10 (possibly by a service over the wide area network 20). The multifunction peripheral device 10 would deploy the patches to the workstations 17 when the workstations 17 attach to the local area network 13.

The multifunction peripheral device 10 can include an email server. In addition to just supporting email transfer functions, the multifunction peripheral device's email service can scan for viruses and inappropriate content and filter spam. The multifunction peripheral device 10 can receive mail filters from a subscribed service as well as from the local users.

In addition to scanning for particular virus patterns in files, the multifunction peripheral device 10 can monitor the local area network 13 for suspicious behavior that might suggest the presence of a virus. For example, abnormal levels of email activity from a particular workstation might be detected and the source quickly isolated.

The multifunction peripheral device 10 can provide support for passwords. This is not only checking for passwords, but could also include periodically changing the passwords. The multifunction peripheral device 10 can also assist with remembering forgotten passwords and with mapping between internal and external passwords. The multifunction peripheral device 10 can support encryption of files and maintenance of their access rights. The multifunction peripheral device 10 can decrypt and present files to those authorized to view the files, while preventing unauthorized access.

As noted above, the multifunction peripheral device 10 can monitor the devices attached to the local area network 13. The multifunction peripheral device 10 can handle the results of the monitoring by reporting the results to an interested party on the local area network 13. Alternatively, the multifunction peripheral device 10 can send the results to the remote device or service 30 for analysis and to either act upon or to recommend action. Examples of possible actions might be to purchase memory, cancel software contracts, or install software updates.

In addition, the multifunction peripheral device 10 can provide domain name services to convert mnemonic names into IP addresses; naming services that clients can query to receive values associated with names; time services that provide accurate fault-tolerant clock synchronization for machines on the network; token services for synchronization and locks; logging services for processing client logs. The multifunction peripheral device 10 can provide email capabilities, file transfer capabilities, and web services.

Thus we see that the multifunction peripheral device can provide a wide variety of common services to the local network. Furthermore it is possible to enable the multifunction peripheral device to provide these services as well as carrying out its primary mission of copy/print/scan/FAX.

FIG. 2 illustrates an overall view of the system architecture of a multifunction peripheral device that can provide the services described above. The architecture we show will be illustrative in purpose; real systems may exhibit a variety of forms which nevertheless contain the basic components that we will describe.

The system includes a core processor element 102. This is some form of computing platform containing a CPU and its associated support components and memory. This core processor is often implemented as a standard PC motherboard with a commercial CPU and support. It may also be implemented using specialized design but most often with commercial CPUs and support chips. The core processor is interfaced to a number of components. There is a print engine, 104 that converts digital signals representing an image into a hardcopy of that image on a recording medium.

There is some form of user interface 106 that allows the users at the machine to select the various functions of the digital printing device, program various job attributes for the particularly selected function, provide other input to the digital printing device, as well as, display informational data from the digital printing device.

The core processor also contains a standard interface to hard disk drives, 108. These disk drives are used for storing program code and also for storing various intermediate image files that may arise during the operation of the multifunction peripheral device as a copier/scanner/printer/FAX machine.

The core processor also contains interfaces to networks, both local 114 and wide area 116. These are typically some form of Ethernet, but are not restricted to be such.

There is a separate interface 112, to a FAX subsystem that communicates with the local telephone network and handles the protocols for FAX communication. The system may also include specialized hardware elements to speed up image processing functions 120, these are controlled by the core processor as well.

Of course the system also includes a scanner 110, for inputting documents to be scanned or copied, and a print engine, 104, that is used to print page images on various media.

In the past the controllers of multifunction peripheral devices were implemented in specialized hardware and custom crafted software. In recent times the trend has been to use commercial off the shelf components such as PC motherboards as the base of the core processor with perhaps extra hardware interfaced through a standard bus like the PCI bus common on PC motherboards, and to use a variety of commercial software products such as Linux or other proprietary Unix-like operating systems (OS) to manage the customized software to handle the functions of the multifunction peripheral device.

It is the existence of these Unix-like OSes that make it possible to implement the extra functions desired in the multifunction peripheral device. A Unix-like OS like Linux contains many of the core communication functions desired. File sharing and network firewall and routing functions are common and a core part of any Unix-like OS. Those functions that are not part of the core OS are available as add-on programs both via the open-source community and by commercial offerings. Table I shows some examples of packages that are available to implement the desired extra services.

TABLE 1

| | |
|---|---|
| Function/Service | Software Package that provices service |
| File storage | Part of OS e.g. NFS |
| (local and remote) | |
| Backup | Commercial packages e.g. Arkeia |
| Encryption/Decryption | Add on to OS e.g. TBD |
| Router/Firewall | Part of OS e.g. IPTables |
| Virus Scan | Commercial packages e.g. TBD |
| Email | Sendmail, Postfix Open Source packages |
| Passwords | Various Open Source e.g. LDAP |
| Domain Name Service | DNS part of OS |
| Time Service | NTP part of OS either direct or via remote |

Part of the implementation of the additional services would be to add either via the user interface or via a network connection a configuration program to set up the services at the time the multifunction peripheral device is installed. This will allow the installers, who would have extra training, to customize each installation for the specific office that the multifunction peripheral device is to be installed in. It would also ensure that the office would not need any specialized training or expertise to be able to take advantage of the extra functionality offered by the system described here.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system comprising:
a multifunction peripheral device, said multifunction peripheral device including a scanning device to convert a document to an electronic image, a printing device to render an electronic image onto a recording medium, a first communication port, and a second communication port;
a wide area network communicatively connected to said first communication port of said multifunction peripheral device; and
a local area network communicatively connected to said second communication port of said multifunction peripheral device;
said multifunction peripheral device providing an interface between said wide area network and said local area network.

2. The system as claimed in claim 1, further comprising:
a plurality of local workstations communicatively connected to said local area network; and
a remote storage device communicatively connected to said wide area network.

3. The system as claimed in claim 2, wherein said multifunction peripheral device manages transferring of files between said local workstations and said remote storage device.

4. The system as claimed in claim 1, wherein said multifunction peripheral device includes a disk storage device to provide storage for said local workstations.

5. The system as claimed in claim 3, wherein said multifunction peripheral device encrypts and decrypts files being transferred between said local workstations and said remote storage device.

6. The system as claimed in claim 1, wherein said multifunction peripheral device includes an e-mail subsystem to provide email service for said local workstations.

7. The system as claimed in claim 1, wherein said multifunction peripheral device includes a router for said local area network.

8. A multifunction peripheral device for providing network services, comprising:
a scanning device to convert a document to an electronic image;
a controller;
a printing device to render an electronic image onto a recording medium;
a first communication port to provide an interface to a local area network; and
a second communication port to provide an interface to a wide area network;
said controller managing communication between said first communication port and said second communication port.

9. The multifunction peripheral device as claimed in claim 8, further comprising a disk storage device.

10. The multifunction peripheral device as claimed in claim 8, wherein said controller encrypts and decrypts files being transferred between said first communication port and said second communication port.

11. The multifunction peripheral device as claimed in claim 8, wherein said controller includes an e-mail subsystem to provide email service.

12. The multifunction peripheral device as claimed in claim 8, wherein said controller includes a router.
